(19) United States
(12) Patent Application Publication
(10) Pub. No.: US 2004/0222953 A1
(43) Pub. Date: Nov. 11, 2004

(54) Low voltage frame buffer for high contrast LCD microdisplay and method therefor

(76) Inventor: Joseph T. Smith, Chandler, AZ (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/431,229

(22) Filed: May 6, 2003

(51) Int. Cl. G09G 3/36

(52) U.S. Cl. 345/87

(57) ABSTRACT

A frame buffer coupled to a LCD pixel comprises a first storage stage and a second storage stage. The frame buffer stores video information to the first storage stage while the second storage stage outputs previously stored video information to the LCD pixel. Video information stored in the first storage stage has a first voltage magnitude. A voltage boost circuit increases the stored video information in the first storage stage to a second voltage magnitude when the second storage stage is coupled for receiving video information from the first stage. The video information of the second voltage magnitude is converted and stored in the second storage stage having the first voltage magnitude.

### FIELD OF THE INVENTION

The present invention relates, in general, to liquid crystal displays (LCD), and more particularly, to a high contrast LCD microdisplay including an analog frame buffer circuit that can be integrated on low voltage semiconductor wafer processes.

### BACKGROUND OF THE INVENTION

There are many different types of display technologies available to the consumer. The cathode ray tube (CRT) is perhaps the most well known and has been used for decades in a wide variety of applications. An image is produced on a phosphor coated CRT on the screen. The phosphors emit visible light when they are excited by electrons output from an electron gun of the CRT.

The phosphors on the CRT screen are organized into a number of lines. A complete image is formed on the screen when the electron beam has traversed across each line that comprises the screen area. A line is defined in the x-axis of the screen and has a predetermined width. The total number of lines in the y-axis determines the resolution of the CRT. In general, the ability to resolve fine detail goes up with higher line counts. For example, HDTV has several times the line count of a standard analog television.

The video information corresponding to an image on the CRT is scanned in line by line. In general, the electron beam emitted from the electron gun is directed by a deflection system to move from left to right to excite a line of phosphors. The intensity of the electron beam varies as dictated by the input video signal. A magnetic lens focuses the beam to create a small moving dot on the phosphor screen. Typically, the video information is input starting with a line at the top of the CRT and incrementally progressing downward to the last line on the bottom of the CRT. Although a CRT is capable of high resolution and is very reliable, it is limited for many applications by power consumption, size, and weight.

Other display technologies have emerged recently such as light emitting diodes (LED), plasma, and digital light processing (DLP). For example, LED displays have been widely used in a variety of applications from calculators to mobile wireless devices. An LED is a solid state device that produces light by exciting electrons to a predetermined energy level where the electron decay corresponds to the release of energy falling in the visible light spectrum. A LED display is typically used in low cost applications such as an alphanumeric display. The technology does not lend itself to high resolution low power video/graphic displays at this time.

Liquid crystal displays (LCDs) were developed in the 1970s and were quickly adapted for use in small display applications such as calculators and mobile devices. The advantages provided by this technology were ease of manufacturing, low cost, and low power consumption. A reflective LCD operates by applying a voltage across a liquid crystal material. The crystal orientation of the liquid crystal material changes as the applied voltage varies. A mirror, behind the liquid crystal material is used to reflect light that passes through the liquid crystal material back to the viewer. The amount of light reflected back through the display to the viewer is dependent on the crystal orientation of the liquid crystal material. In practice, the reflected light ranges from all light reflected back (appears white to the viewer) to none of the light reflected back (appears black to the viewer). Grey shades between white and black are created by adjusting the voltage on the liquid crystal material to allow some light (but not all) to be reflected back.

A liquid crystal display comprises a matrix of pixels that are arranged in rows and columns. Each pixel is a liquid crystal element that is individually electrically controllable and reflects light back to the viewer. Typically, a LCD comprises a layer of liquid crystalline material suspended between two glass plates or between a glass plate and a substrate. LCD technology is suitable for high resolution displays because the pixel density per unit display area can be made very small. LCD displays have adapted well to the changing environment. LCD displays are still used in low information content items such as small alphanumeric displays but are migrating to wide spread use in television and computer applications with high video content.

Contrast is one of the most critical parameters for a high quality liquid crystal display. In general, the input video signal is not directly applied to the LCD but is buffered through a frame buffer circuit. High contrast images are produced when the LCD driver circuitry can accurately replicate the input video signal voltage. The contrast is directly related to the magnitude of the voltage that is applied across the LCD, the repeatability of voltage levels, and the linearity of the incremental step voltages corresponding to varying degrees of grey shades.

Cost is a significant driver in determining which display technology will become the market choice in the future. Coupled with the cost objective is the need to meet consumer demands of increased image quality/capability. To meet both goals, it is desirable to utilize higher density semiconductor processes that will result in smaller die size and lower manufacturing cost. Typically, smaller geometry devices have lower breakdown voltages. This is problematic because a low transistor breakdown voltage can limit the range on the LCD driver circuitry thereby reducing the contrast of the display. Furthermore, the translation of the video signal through the frame buffer circuitry can degrade linearity over the range of grey shades. It would be appreciated if a frame buffer could be provided that maximizes the useable voltage range to increase contrast and minimizes linearity problems due to voltage translation and buffering. Additional desirable features will become apparent to one skilled in the art from the foregoing background of the invention and the following detailed description of a preferred exemplary embodiment and appended claims.

### BRIEF SUMMARY OF THE INVENTION

In accordance with the teachings of the present invention, there is provided a frame buffer circuit comprising a first storage stage and a second storage stage. Video information of a first voltage magnitude is stored in the first storage stage. The video information of the first voltage magnitude is increased to a second voltage magnitude when provided to the second storage stage. The second storage stage receives the video information of the second voltage magnitude and stores a voltage of the first voltage magnitude.

### BRIEF DESCRIPTION OF THE DRAWINGS

The present invention will hereinafter be described in conjunction with the accompanying drawings wherein like reference numerals denote like elements, in which:

FIG. 1 is schematic diagram of an array of pixels comprising a liquid crystal display;

FIG. 2 is a block diagram of a frame buffer;

FIG. 3 is a timing diagram useful in explaining the operation of the block diagram shown in FIG. 2;

FIG. 4 is a schematic diagram of a storage stage;

FIG. 5 is a schematic diagram of a first embodiment of a frame buffer circuit in accordance with the present invention;

FIG. 6 is a timing diagram useful in explaining the operation of the schematic diagram shown in FIG. 5;

FIG. 7 is a schematic diagram of a storage stage; and

FIG. 8 is a schematic diagram of a frame buffer for a color sequential LCD pixel.

### DESCRIPTION OF THE PREFERRED EXEMPLARY EMBODIMENT

In general, a liquid crystal display (LCD) is a structure comprising a substrate, a layer of liquid crystal material, a conductive layer, and a glass or transparent protective layer. Formed on the substrate are a matrix of light reflective pads or mirrors. The mirrors are typically made of a conductive material. The mirrors fabricated on a silicon substrate are made of the aluminum used for electrical interconnect. The liquid crystal material is placed between the substrate and conductive layer. The conductive layer is a transparent material such as indium-tin-oxide (ITO). The glass or other transparent material is a barrier to prevent exposure of the LCD to the external environment. A seal on the periphery of the LCD prevents the liquid crystal material from leaking out of the display.

Each mirror corresponds to a pixel of the liquid crystal display. Typically, a frame corresponds to a fixed time period during which a video signal is applied to each pixel of the display thereby producing an image. All of the discrete events required to enable each pixel on the display occur at high speeds such that image changes frame by frame are not discernable to the human eye and are viewed as continuous change similar to that of a movie film.

Operation of an individual pixel illustrates how an image is produced. A reference voltage is applied to the opposing transparent conductive layer common to every pixel of the display. A voltage (video signal) is applied to the mirror of the pixel. A differential voltage is created across the liquid crystal material from mirror to the common conductive layer. The molecules of the liquid crystal material orient themselves in a relationship that depends on the magnitude of the differential voltage. Ambient or created light passes through the glass layer and the conductive layer of the pixel. As mentioned previously, the orientation of the molecules determine how much light passes through the liquid crystal material above the pixel and is reflected by the pixel mirror back to the viewers eye. The range of the differential voltage applied to the pixel allows change from white (where all the light is reflected back) to black (where none of the light is reflected back). In general, but dependent on the liquid crystal mode, the condition where none of the light is reflected back (the pixel is black) is produced when the maximum differential voltage is applied. The varying degrees of light that is reflected back are called grey shades which are produced by inputting voltages less than the maximum differential voltage.

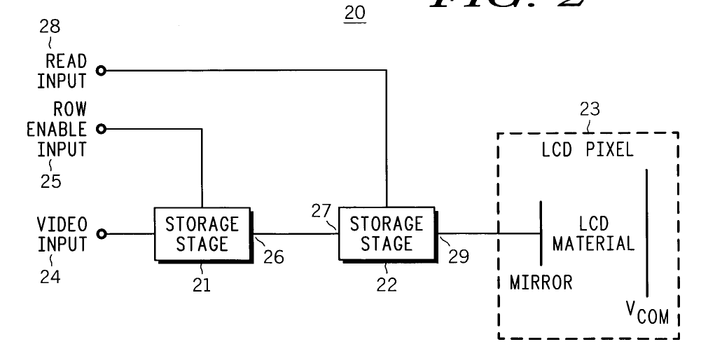

FIG. 1 is a schematic diagram of an array of pixels 10 comprising a liquid crystal display. In general, a frame buffer circuit (not shown) is formed beneath the mirror of each pixel. Each frame buffer circuit receives/stores an analog voltage analogous to the video signal and applies the video signal to the mirror of the corresponding pixel. As shown, array of pixels 10 is arranged in an array of M rows and N columns. Each row of pixels has a common row line control input that enables the row of pixels to receive an analog video signal. The row line control inputs are labeled Row 1, Row 2, . . . Row M. Similarly, each column of pixels has a common column input to which a video signal is applied. The column control inputs are labeled Col 1, Col 2, . . . Col N.

The frame time is a period of time required to provide a video signal to each pixel of array of pixels 10. In the embodiment shown in FIG. 1, the video information is provided row by row. For example, the row control input Row 1 enables the circuitry of each pixel in the first row to receive the video signals applied to Col 1-Col N. Row disabling signals are applied to Rows 2-M. Upon storing the video signal for each pixel in the first row, the signal applied to Row 1 disables the first row. A row enabling signal is then applied to Row 2 and the second row stores the video signals applied to Col 1-Col N for each pixel in the second row. Row disabling signals are applied to Row 1 and Row 3-M while the second row is enabled for receiving the video signals. This process continues sequentially until Row M has stored it's video signals completing the input of an image for this frame. Frame by frame changes of video information occurs at a speed that is not discernable to the human eye such that changes appear to be contiguous and natural.

FIG. 2 is a block diagram of a frame buffer 20 for an individual pixel to illustrate the basic concepts of a frame buffer pixel array architecture. Frame buffer 20 comprises a storage stage 21 and a storage stage 22. Storage stage 21 has a video input 24, a row enable input 25, and a video output 26. Storage stage 22 has a video input 27, a read input 28, and a video output 29. Video output 26 of storage stage 21 connects to video input 27 of storage stage 22. Video output 29 of storage stage 22 connects to a mirror of LCD pixel 23. Vcom is a reference voltage applied to the opposing common transparent electrode for LCD pixel 23. A differential voltage corresponding to the voltage at video output 29 is created across the liquid crystal material of LCD pixel 23. The differential voltage electric field orients the liquid crystal molecules to determine how much light passes through LCD pixel 23 to be reflected back (via the mirror) to the viewer. The differential voltage is the difference between the voltage applied to the mirror and Vcom. It should be noted that frame buffer 20 and LCD pixel 23 are one of many frame buffers and LCD pixels that comprise a typical LCD display.

Two stages of storage are used in pixel frame buffer 20. Frame buffer 20 allows the storage of a video signal while the previously stored video signal is provided to the mirror of LCD pixel 23. In particular, equal differential voltages of opposite polarity are provided to LCD pixel 23. The reason for applying two equivalent video signals in sequence to LCD pixel 23 is to prevent applying a signal of the same voltage polarity continuously across the liquid. Inverting the polarity of the video signal in alternating frames while keeping the differential voltage constant across the liquid crystal material has been proven to suppress the degradation of the liquid crystal. It should be noted that the liquid crystal material is sensitive to the differential voltage across it (from mirror to Vcom) and not to just the magnitude of the stored voltage on the pixel mirror. For example, in inversion n, 4 volts on the pixel mirror and with Vcom set to 0 volts produces a differential voltage of 4 volts. In inversion n+1, the Vcom electrode is flipped to 5 volts and 1 volt is stored on the pixel mirror producing the complementary 4 volts across the liquid crystal (Vcom-Vmirror).

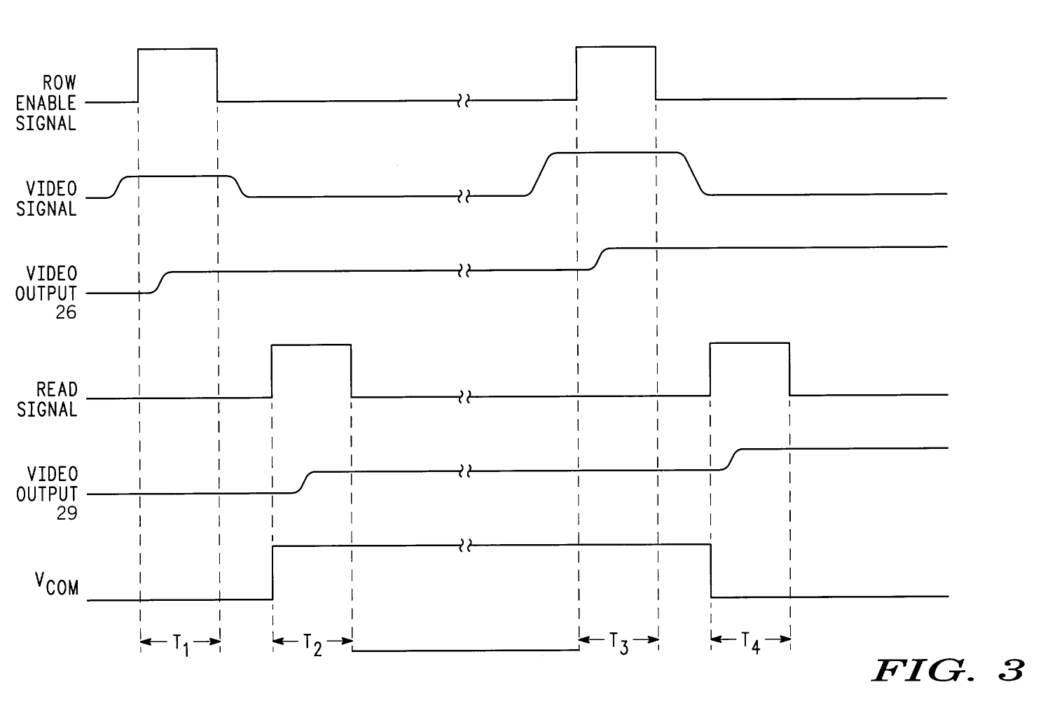

FIG. 3 is a timing diagram for a single pixel useful in explaining the operation of the functional block diagram shown in FIG. 2. As mentioned hereinabove, pixel frame buffer 20 has two stages of storage. A video signal is first stored in storage stage 21. The stored video signal is then transferred to storage stage 22. The stored video signal is applied to the mirror of LCD pixel 23. Using two stages of storage allows frame buffer 20 to store a video signal while the previously stored signal is output to the mirror of LCD pixel 23. It should be noted that frame buffer 20 and LCD pixel 23 could be one of millions of frame buffers and LCD pixels that comprise a liquid crystal display.

The timing diagram is broken into four timing periods T1, T2, T3, and T4 where significant events occur. A storage sequence begins when a row enable signal applied to row enable input 25 is asserted. Storage stage 21 is enabled to receive a first video signal applied to video input 24. The actual voltage magnitude sampled in storage stage 21 is the voltage at video input 24 when the row enable signal is de-asserted. The read signal applied to read input 28 is de-asserted during this period thereby decoupling storage stage 22 from receiving the voltage at video output 26. Storage stage 21 is then decoupled from receiving the video signal when the row enable signal is de-asserted. Video output 26 now outputs a voltage equal to the first video signal.

In time period T2, a read signal applied to read input 28 is asserted. Storage stage 22 is enabled for receiving the first video signal at video output 26. Video output 29 of storage stage 22 transitions to a voltage equal to the first video signal and the liquid crystal material of LCD pixel 23 changes corresponding to the voltage difference between the voltage at video output 29 and the counter electrode coupled to the voltage Vcom. Storage stage 22 is then disabled from receiving a signal from storage stage 21 when the read signal is de-asserted. Storage stage 22 now has stored a voltage equal to the first video signal.

In one embodiment, storage stage 21 for each individual pixel is loaded sequentially with a video signal until the entire first frame of video information is stored within the pixel array during the time period T1. At time T2, the read signal is asserted and the video voltage stored in storage stage 21 is transferred to storage stage 22 for the entire frame of pixels. At the same time, the read signal is asserted, the polarity of Vcom counter electrode is flipped to provide the appropriate complementary differential voltage.

In period T3 the row enable signal transitions from the low state to a high state, enabling storage stage 21 to store the video signal for the next frame. The row enable signal transitions from the high state to a low state, decoupling storage stage 21 from the input video signal. A voltage equal to the second video signal is stored and output at video output 26. Similar to what was described hereinabove, each row of the pixel array sequentially receives, stores, and outputs an inverted/complement second video signal until all rows have been written to.

Immediately prior to period T4, Vcom transitions to an inverted or complement reference voltage. For example, Vcom changes from the power supply voltage/high state (ex. 5 volts) to ground/low state (0 volts). Next, in time period T4, the read signal then transitions from the low state to a high state enabling storage stage 22 to store a voltage equal to the second video signal. In this embodiment, the voltage difference between the second video signal and the inverted/complement reference voltage Vcom is identical to the difference voltage between the first video signal and the reference voltage Vcom thus biasing LCD pixel 23 with the same differential voltage magnitude but opposite polarity. LCD pixels are sensitive only to the differential voltage across it and not the polarity. The read signal then transitions from the high state to a low state disabling storage stage 22 from storing a voltage.

What has been described is an idealized operation of a frame buffer circuit. In practice, a frame buffer is not able store voltages identically nor for an indefinite period of time. Furthermore, there are significant issues with the voltage levels that can be stored and the linearity over the operating voltage range.

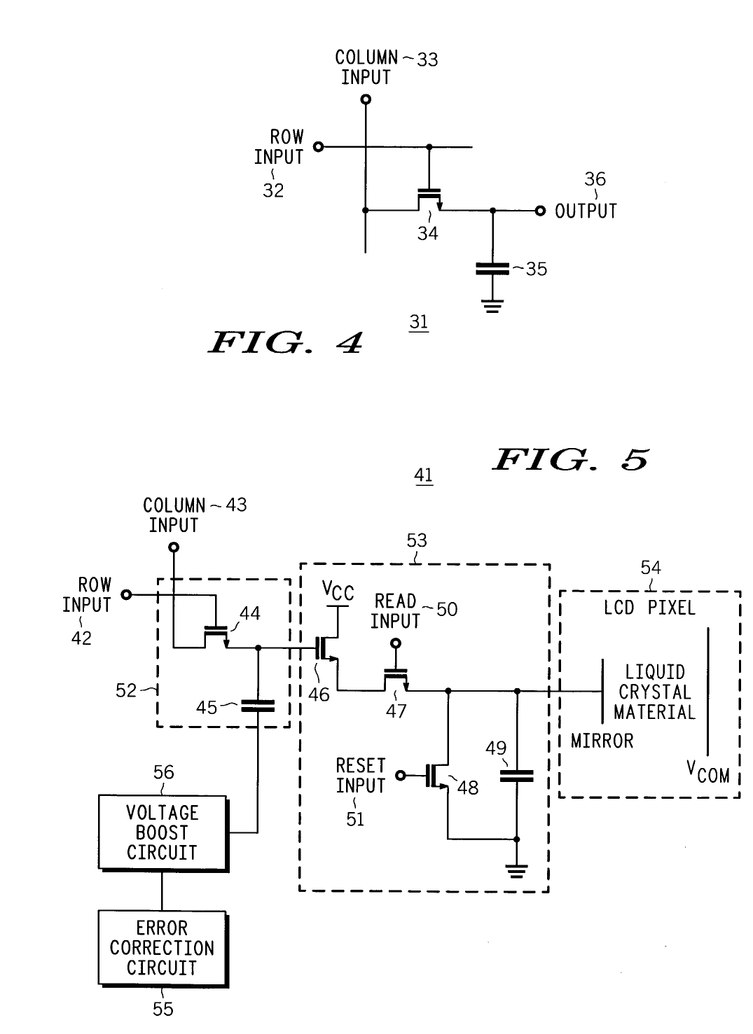

FIG. 4 is a schematic diagram of a storage stage 31.

Storage stage 31 comprises a transistor 34 and a capacitor 35. Transistor 34 includes a drain coupled to a column input 34, a gate coupled to a row input 32, and a source coupled to an output 36 of storage stage 31. A first terminal of capacitor 35 couples to output 36 and second terminal of capacitor 35 couples to ground.

Storage stage 31 is an element common to frame buffers of a LCD display for storing a video signal. The video signal is applied to column input 33. A row enable signal applied to input 32 turns on transistor 34. Transistor 34 is a pass transistor that transfers the voltage at column input 33 to capacitor 35. Capacitor 35 is decoupled from column input 33 when the row enable signal turns off transistor 34. Prior art frame buffers have successfully used this circuit configuration. Typically, these frame buffers were designed using large geometry devices with high breakdown voltages. Using large supply voltages ensures that the appropriate voltages can be generated at output 36 for high contrast.

The semiconductor industry is an extremely competitive market. Companies that can provide high quality solutions at lower cost will gain market share. It is beneficial to utilize higher density/smaller gate length wafer processes from a cost perspective. The problem with moving to these high density processes is that higher complexity circuits are required to achieve similar results due to lower breakdown voltages of the transistors and limitations on signal swings as the power supply voltage is reduced.

FIG. 5 is a schematic diagram of a frame buffer 41 in accordance with the present invention. Frame buffer 41 is operational for low voltage high density wafer processes. For example, frame buffer 41 will yield a small cell size that can be efficiently replicated for LCD arrays having millions of pixels. The high cell density is achieved by using a 5 volt, 0.25−0.5 micron wafer process. Unlike prior art frame buffer circuits, frame buffer 41 is capable of providing a high contrast, highly linear output signal useable for quality LCD displays and is tolerant to typical wafer process variations. Moreover, it can be implemented in wafer processes commonly available in wafer foundries that yields lower die cost.

Frame buffer 41 comprises a storage stage 52 and a storage stage 53. Frame buffer 41 provides an output voltage to a mirror of LCD pixel 54. A differential voltage across the liquid crystal material in LCD pixel 54 orients the molecules of the liquid crystal material. The crystal orientation determines how much light passes through the liquid crystal material and is reflected back from the mirror. Typically, a maximum differential voltage aligns the molecules of the liquid crystal material so that no light is reflected back to the viewer (black pixel). Conversely, a minimum differential voltage (0 volts) allows all of the light to be reflected back to the viewer (white pixel). Two stages of storage are used in frame buffer 41 to allow a video signal for the next frame to be stored in storage stage 52 while storage stage 53 outputs the stored video signal for the previous frame.

Storage stage 52 comprises a transistor 44 and a capacitor 45. Transistor 44 includes a drain coupled to a column input 43, a gate coupled to a row input 42, and a source coupled to a first terminal of a capacitor 45. Transistor 44 is a pass transistor for coupling a video input signal applied to column input 43 to capacitor 45. Alternately, transistor 44 can be replaced with a CMOS transmission gate. An error correction circuit 55 couples to a voltage boost circuit 56. An output voltage of voltage boost circuit 56 couples to a second terminal of capacitor 45. Error correction circuit 55 and voltage boost circuit 56 provides a first voltage to the second terminal of capacitor 45 when transistor 44 is enabled. Error correction circuit 55 and voltage boost circuit 56 provides a second voltage to the second terminal of capacitor 45 when transistor 44 is disabled and storage stage 53 is enabled to store a voltage.

Storage stage 53 comprises a transistor 46, a transistor 47, a transistor 48, and a capacitor 49. Transistor 46 includes a drain coupled to a supply voltage Vcc, a gate coupled to the first terminal of capacitor 45, and a source. Transistor 46 is in a voltage follower configuration. The voltage at the source of transistor 46 is approximately the voltage at the first terminal of capacitor 45 less the threshold voltage of transistor 46. In general, transistor 46 is subject to backbias effects that change the threshold voltage of the device. This occurs because the source and tub of transistor 46 are not at the same voltage potential under different operating conditions. This problem will be discussed in more detail later in this detailed description.

Transistor 47 includes a drain coupled to the source of transistor 46, a gate coupled to a read input 50, and a source coupled to a first terminal of capacitor 49. Transistor 47 is in a pass transistor configuration. Alternately, transistor 47 could be replaced with a CMOS transmission gate. Typically, the signal applied to read input 50 to enable transistor 47 is a digital signal at either ground (low state) or the supply voltage Vcc (high state). Capacitor 49 is charged to a voltage through transistors 46 and 47. In general, the maximum voltage that can be stored on capacitor 49 is limited by transistor 46. Transistors 47 (and for that matter transistor 44) in a pass transistor configuration can be made to operate close to ideal switches by implementing transmission gates or using other circuit techniques to optimize performance of a single transistor in a pass transistor configuration as is well known by one skilled in the art.

Transistor 48 includes a drain coupled to the first terminal of capacitor 49, a gate coupled to a reset input 51, and a source coupled to ground. Capacitor 49 includes the first terminal coupled to a mirror of LCD pixel 54 and a second terminal coupled to ground. Transistor 48 is used to discharge capacitor 49 to ground prior to enabling transistor 47 to begin a storage sequence.

A differential voltage across the liquid crystal material of LCD pixel 54 is the difference between the reference voltage Vcom and the voltage applied to the mirror. Typically, Vcom transitions from ground and the supply voltage Vcc respectively when video information is stored and the complement of the video information is stored in storage stage 53.

Operation of the circuit is best understood by putting frame buffer 41 in context to the type of application it will be used in and the wafer processing constraints placed on the design. High definition projection LCDs require a large number of pixels to achieve the resolution required. Utilizing high voltage wafer processes (greater than 8 volt) with devices having gate lengths greater than 1 micron results in a design that is not economically feasible for a display having millions of pixels. Low voltage high density wafer processes will reduce the cell size to a level suitable for multi-million pixel applications but only if the performance criteria can be met.

Conventional frame buffer circuits operating on a 5 volt/0.25−0.5 micron wafer process suffer in both contrast and linearity. The output voltage range using a 5 volt supply on a conventional frame buffer circuit yields an output voltage swing of approximately three volts or less. Linearity is also less than desirable. The resultant display performance when viewed by the the human eye is not of the quality needed for a high end display market. It has been found that a frame buffer with an output voltage swing from 0-4 volts provides sufficient contrast for the high end market.

A large array of LCD pixels is required for a projection LCD application. For example, a HDTV (high definition television) application requires a pixel array of 1920 columns×1080 rows. This corresponds to over 2 million pixels. The size of the pixel array could be substantial if a pixel consumes a large area. Die size directly relates to cost. Perhaps more important, the opportunity for good die on a wafer goes up as the die size is reduced. In general, the frame buffer circuitry resides under the mirror of each pixel. Either the pixel or the frame buffer circuitry can be the limiting factor on the pixel cell size. Typically, it is the frame buffer circuitry that determines the size of a pixel.

For example, an 8 volt wafer process having a 1 micron critical dimension may be desirable for a high contrast LCD display because of the output voltage swing. A problem that prevents using this wafer process is a pixel cell size of approximately 20 u×20 u (400 microns square microns). A display having millions of pixels with a 400 square micron pixel size would be excessively large. It should be noted that the large pixel cell size is due to the circuitry and not the LCD pixel.

A pixel cell size of 11.5 microns per side with 0.5 micron cell to cell spacing is achievable with a 0.5 micron wafer process. A die size of one inch (25.4 millimeters) per side or more would be expected for a large pixel array with a pixel cell size in this range. From an economic perspective, this is the upper end of the range of what would be considered a viable chip size. Pixel cell sizes of 8-9 microns per side are being pursued and would be considered more desirable for large pixel count LCD applications such as projection television. An additional benefit of reducing pixel size is the cost of the optics. The cost of optics used to create the image for the LCD pixel goes down as the pixel cell size shrinks.

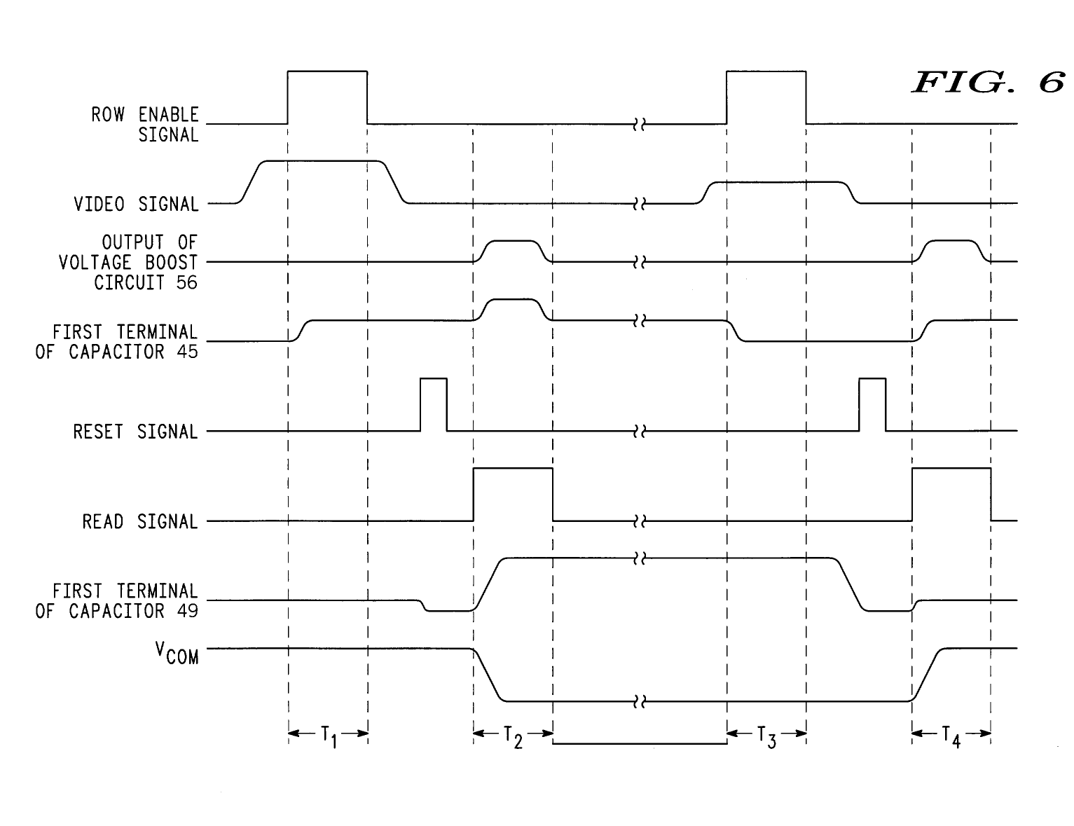

FIG. 6 is a timing diagram useful in explaining the operation of the schematic diagram shown in FIG. 5. Although a single frame buffer is shown in FIG. 5, it should be understood that frame buffer 41 and LCD pixel 54 are one of many frame buffers and LCD pixels that form a LCD array.

In general, the pixel layout of a LCD array is in rows and columns. In an embodiment, of the LCD array each frame buffer has two stages of storage. In particular, the two stages of storage are serially coupled such that a video signal is first stored in the first stage and in a separate step stored in the second stage. This allows a frame buffer to be storing the video signal for the next frame while the current signal is output to the corresponding LCD pixel.

Typically, video information is stored in the LCD array row by row. In an embodiment of the LCD array, the video information is provided to each row of the display. An inverted or complementary signal of the video information in conjunction with an inverted Vcom (reference voltage of an LCD pixel) is then provided to the LCD array row by row in the next video frame. The video signal and inverted video signal produce equal differential voltages (of opposite polarity) across a LCD pixel. A LCD pixel is sensitive only to the magnitude of the differential voltage and not the polarity. As mentioned previously, providing an inverted signal eliminates liquid crystal degradation over time and reduces flicker due to leakage current reducing the stored voltage in the frame buffer.

It should be noted that the timing diagram of FIG. 6 is designed to show the operation of circuitry internal to frame buffer 41 and is not meant to show global timing on how video information would be applied to an array of LCD pixels. In this example, a sequence shows video information being stored in storage stage 52 first and at a later time transferred to storage stage 53. This is followed by an inversion sequence where an inverted or complementary video information in the next frame is stored in storage stage 52 and at a later time the inverted video information is transferred in storage stage 53. Vcom of LCD pixel 54 is inverted when the inverted video information is stored in storage stage 53 such that the differential voltage across LCD pixel 54 under this condition is equal to the differential voltage created initially by the video signal and non-inverted Vcom.

The timing diagram of FIG. 6 is broken into four timing events T1, T2, T3, and T4. In time period T1, video information is applied to column input 43 and is stored in storage stage 52. A row signal transitions high, enabling transistor 44 to couple the video information to capacitor 45. The output of voltage boost circuit 56 is at ground potential. Capacitor 45 is charged to a voltage equal to the signal applied to column input 43 when the row enable signal transitions from the high state to a low state. The row enable signal in the low state disables transistor 44 and decouples the video information on column input 43 from capacitor 45.

In this example, the supply voltage Vcc is 5 volts. Storage stage 52 is capable of storing a minimum voltage range of approximately 0-4 volts to meet performance requirements for a high contrast display. As mentioned previously, a transmission gate employing both n-channel and p-channel transistors can be used to ensure the video information is coupled to capacitor 45.

A reset signal pulse occurs after the row enable signal transitions to the low state. The reset signal enables transistor 48 of storage stage 53 to discharge capacitor 49 to ground potential. In an embodiment of the LCD display, the reset signal is a global signal resetting all the frame buffers of the pixel array simultaneously or the reset signal is applied row by row. Discharging capacitor 49 is done with such speed that a change in the liquid crystal display image is not perceptible. In other words, a person watching the screen does not see the image turn all white due to the reset because of the speed at which video information is provided to the LCD display.

In time period T2, storage stage 53 is enabled to store video information. The path to charging capacitor 49 of storage stage 53 is through transistors 46 and 47. Transistor 46 is in a voltage follower configuration that receives a voltage from storage stage 52. A storage sequence in storage stage 53 begins when a read signal transitions from the low state to a high state which enables transistor 47. Transistor 47 is in a pass transistor configuration and couples transistor 46 to capacitor 49. Similar to transistor 44, transistor 47 and the enabling signal provided thereto combine to allow a 0-4 volt signal at the source of transistor 46 to capacitor 49. Transistor 47 is replaceable with a transmission gate if increased voltage range is desired.

Transistor 46 follows the voltage at the first terminal of capacitor 45. The voltage at the source transistor 46 is reduced by approximately threshold voltage (Vth) of the device. The voltage drop due the threshold voltage of transistor 46 in transferring the voltage to storage stage 53 will severely degrade the contrast of the liquid crystal display by reducing the maximum voltage swing. Voltage boost circuit 56 and error correction circuit 55 compensate for the voltage reduction due to the voltage follower transistor 46. Voltage boost circuit 56 provides a voltage pulse during the storage sequence of storage stage 53 that additively increases the voltage at the first terminal of capacitor 45. The voltage pulse provided by voltage boost circuit 56 coincides with the read signal enabling transistor 47. Thus, storage stage 52 stores a voltage having a first magnitude during time period T1 and outputs a voltage having a second magnitude during T2 that is received by storage stage 53.

Ideally, voltage boost circuit 56 compensates for the threshold voltage (Vth) drop from gate to source of transistor 46 when capacitor 49 is charged up. In other words, the voltage pulse (Vp) output by voltage boost circuit 56 has a magnitude equal to the Vth of transistor 46. Under this condition, the voltage at the gate of transistor 46 is Vth+the voltage stored on capacitor 45. The voltage at the source of transistor 46 is then equal to the voltage stored on capacitor 45. Simulation results of frame buffer 41 with voltage boost circuit 56 show video information in a four volt range can be transferred to storage stage 53 being fabricated on a high density 5 volt wafer process.

In general, the source of transistor 46 would not be tied to the bulk in most wafer processes that would be used to fabricate frame buffer 41. Under the condition where the source is not tied to the bulk of transistor 46, back bias effects will change the threshold voltage dramatically. The threshold voltage will increase as the source of transistor 46 is brought to higher voltages. For example, a change in threshold voltage of transistor 46 by one volt or more is possible as the source approaches Vcc (5 volts). A second consideration is that the magnitude of the pulse from voltage boost circuit 56 must not place transistors 44 or 46 in a high voltage breakdown condition as it raises the voltage at the first terminal of capacitor 45. A third consideration is the range of threshold voltage due to wafer processing variations.

Simulations for frame buffer 41 with a 5 volt supply voltage indicate that the dynamic range of storage stage 53 increases with a pulse magnitude from voltage boost circuit 56 of approximately 1 volt or greater. The magnitude of the threshold voltage of transistor 46 increases (linearly) as the voltage at the source of transistor 46 rises. The fact that the threshold voltage of transistor 46 changes depending on the voltage at its source induces non-linearities that cannot be compensated for by a voltage pulse having a constant magnitude.

The selection of the magnitude of the voltage pulse from voltage boost circuit is a compromise and is based on linearity and voltage range. In an embodiment of frame buffer 41, the voltage pulse magnitude of voltage boost circuit 56 is selected to provide the best linearity over the widest possible voltage range. Linearity in this context describes the voltage magnitude of the video signal at the input of frame buffer 41 compared to the voltage magnitude actually stored on capacitor 49. Perfect linearity is achieved when the video information applied to frame buffer 41 is identical to the voltage provided to the mirror of LCD pixel 54. Another factor is the voltage range that can be stored on capacitor 49. A four volt range is highly desirable with wafer processes that operate with a 5 volt supply voltage Vcc. Simulation results indicate that frame buffer 41 is highly linear from 0 to 3 volts, has a four volt output swing, and minimizes device breakdown issues when the voltage pulse magnitude of voltage boost circuit 56 is kept within a range of 1-2 volts.

Error correction circuit 55 is a control circuit for adjusting the voltage pulse magnitude of voltage boost circuit 56. For example, a simple voltage magnitude correction is made depending on the threshold voltage of transistor 46 to correct for wafer process variations. Conversely, corrections could be made to improve linearity by taking into account what the actual threshold voltage of transistor 46 would be under backbias conditions by sensing the voltage stored in storage stage 52 prior to enabling storage stage 53. Sensing the voltage on capacitor 45 would determine the voltage on the source of transistor 46 and thus the amount of backbias/change in threshold voltage.

The read signal transitions from the high state to a low state turning off transistor 47 and decoupling storage stage 53 from receiving a voltage from storage stage 52. Concurrently, voltage boost circuit 56 transitions to ground. The video information corresponding to the voltage stored on capacitor 49 is applied to the mirror of LCD pixel 54. The difference voltage between Vcom and the voltage applied to the mirror of LCD pixel 54 from storage stage 53 adjusts the orientation of the molecules of the liquid crystal material. The orientation of the molecules and the light reflected back from the LCD pixel 54 uniquely corresponds to the video information stored in frame buffer 41.

In an embodiment of the LCD display, video information for the next frame is stored row by row until every pixel of every row of the LCD stores the current video information provided for the frame. In parallel, frame buffer 41 continues to apply the voltage stored in storage stage 53 to the pixel mirror. The break in the timing diagram relates to the time when video information is being written to other rows of the LCD display.

In time period T3, frame buffer 41 stores the next frame of inverted/complementary video information on capacitor 45. The row signal transitions from the low state to a high state enabling transistor 44 to couple the inverted video information at column input 43 to capacitor 45. Capacitor 45 is then decoupled from column input 43 when the row enable signal transitions from the high state to a low state. The sequence repeats row by row until the entire pixel array is loaded with one frame of video information. Next, a reset pulse enables transistor 48 to discharge capacitor 49 of storage stage.

In time period T4 the inverted/complementary video information is transferred from storage stage 52 to storage stage 53. The read signal transitions from the low state to a high state enabling transistor 47. At approximately the same time, voltage boost circuit 56 outputs a voltage pulse (1-2 volts) that increases the voltage at the gate of transistor 46 during the storage sequence of storage stage 53. Vcom simultaneously transitions from ground to the supply voltage Vcc (5 volts). The inverted video information is stored on capacitor 49 which is coupled to the mirror of LCD pixel 54.

Storage stage 53 is decoupled from receiving a voltage from storage stage 52 when the read signal transitions from the high state to a low state. Similarly, the voltage pulse provided by voltage boost circuit 56 transitions to ground. The difference voltage across the liquid crystal material of LCD pixel 54 is Vcom less the voltage on capacitor 49 (inverted video information). In this example, the magnitude of the differential voltage created in T4 across the liquid crystal material of LCD pixel 54 is the same as the differential voltage created in time period T2. The polarity of the differential voltages created in T2 and T4 are opposite but the electrical field strengths are identical. Thus, providing the same effect to the liquid crystal.

A layout of frame buffer 41 yielded a cell size of 9.5 microns per side on a high density 5 volt wafer process which is highly cost effective and manufacturable for liquid crystal displays having greater than 1 million pixels.

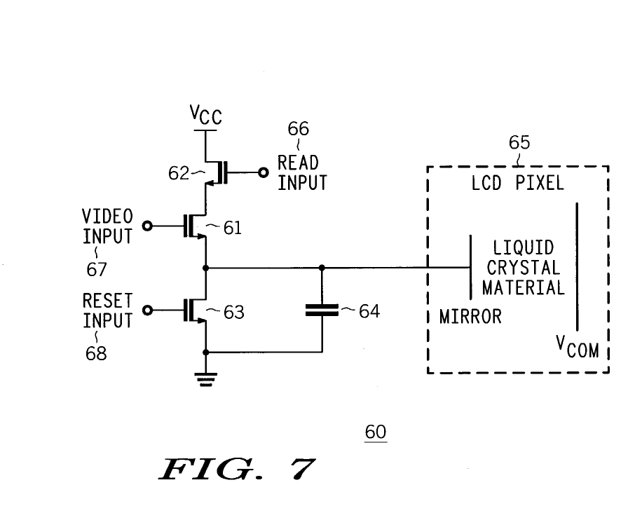

FIG. 7 is a schematic diagram of a storage stage 60. A frame buffer as described hereinabove has two storage stages that allow video information to be stored in a first storage stage while a second storage stage outputs previously stored video information to a LCD pixel. Storage stage 60 is an alternate embodiment of the second storage stage of a frame buffer. Storage stage 60 comprises a transistor 61, a transistor 62, a transistor 63, and a capacitor 64.

Transistor 61 is in a voltage follower configuration and includes a drain, a gate coupled to a video input 67, and a source coupled to a first terminal of capacitor 64. Video input 67 would couple to an output of a first storage stage in a frame buffer application.

Transistor 62 is in a pass transistor configuration and includes a drain coupled for receiving a supply voltage Vcc, a gate coupled to a read input 66, and a source coupled to the drain of transistor 61. A read input signal applied to read input 66 enables storage stage 60 to receive video information applied to video input 67. Transistor 62 is replaceable with a transmission gate if improved performance is desired.

Transistor 63 discharges capacitor 64 to ground prior to the read signal enabling storage stage 60 to receive the video information. Transistor 63 includes a drain coupled to the first terminal of capacitor 64, a gate coupled to a reset input 68, and a source coupled to ground. A reset signal is applied to reset input 68 to discharge capacitor 64.

Capacitor 64 includes the first terminal coupled to the mirror of a LCD pixel 65 and a second terminal coupled to ground. Capacitor 64 stores a voltage equal to the voltage information applied to video input 67 when transistor 62 is enabled. The video information is decoupled from capacitor 64 when transistor 62 is disabled.

In general, the difference between the storage stage 60 and the embodiment in FIG. 5 is the location of the pass transistor (transistor 62). Either configuration is equally usable in a low voltage high density frame buffer application.

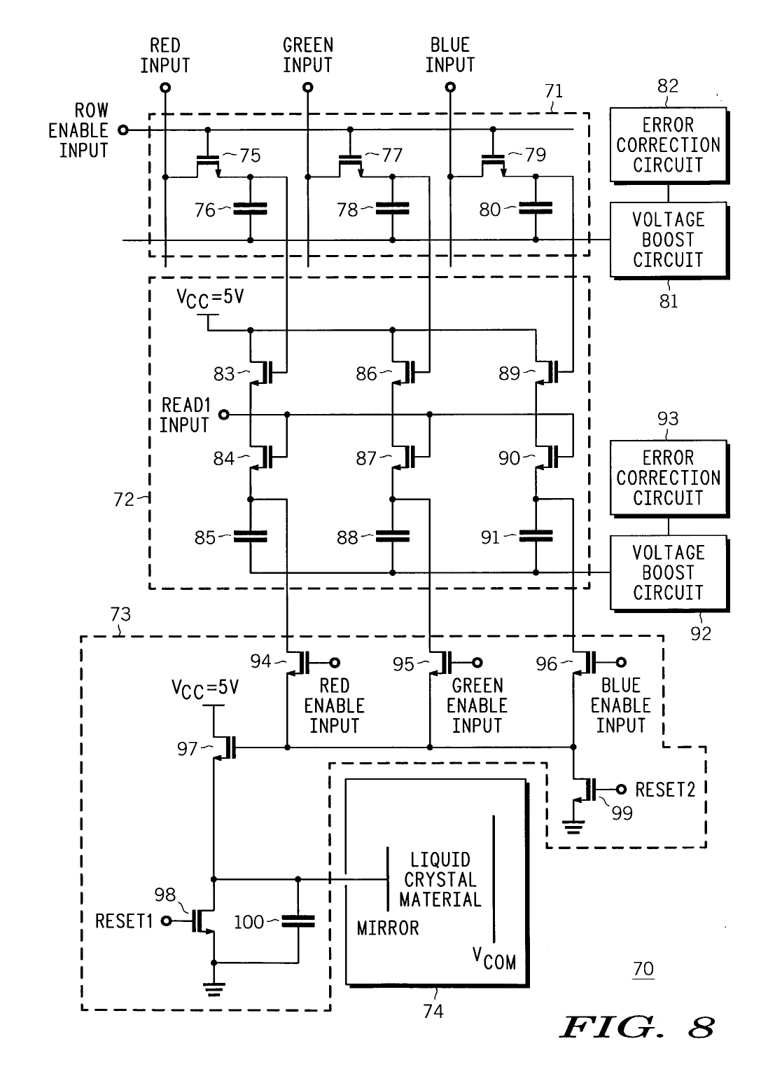

FIG. 8 is a schematic diagram of a frame buffer 70 for a color sequential LCD) pixel cell. In an embodiment of frame buffer 70, red, green, and blue video information is stored and provided to a LCD pixel 74. The red, green, and blue video information is output to LCD pixel 74 within a time period corresponding to a single frame. Inverted video information is also provided within the next frame as discussed hereinabove to extend the life of the LCD display. Frame buffer 70 and LCD pixel 74 are one of thousands or millions of frame buffers and pixel that comprise a LCD display.

LCD pixel 74 does not in itself provide color to the viewer. The video information provided to LCD pixel 74 determines the grey shade of LCD pixel 74. A color wheel outputs red, green, and blue color. The color wheel is synchronized to frame buffer 70 such that the grey shade output by LCD pixel 74 corresponds to the appropriate color. The amount of red, green, or blue seen by the viewer is determined by the amount of light reflected back through each pixel of the LCD display. The frames of video information are provided at a speed (typically 60 Hz) whereby discrete events that occur in LCD pixel 74 are not distinguishable to the human eye but appear as continuous change similar to what occurs in nature.

Frame buffer 70 comprises a storage stage 71, a storage stage 72, and an output stage 73. Red, green, blue (RGB) video information is first stored in storage stage 71. The stored RGB video information is then transferred to storage stage 72. The red, green, and blue video information stored in storage stage 72 is then sequentially coupled to the mirror of LCD pixel 74. Frame buffer 70 is capable of storing the next frame of RGB video information while the previously stored video information is provided to LCD pixel 74.

Storage stage 71 comprises a transistor 75, a transistor 77, a transistor 79, a capacitor 76, a capacitor 78, and a capacitor 80. Transistors 75, 77, and 79 are in a pass transistor configuration. Transistor 75 and capacitor 76 combine to store red video information. Transistor 75 includes a drain coupled to a red input, a gate coupled to a row enable input, and a source coupled to a first terminal of capacitor 76. A second terminal of capacitor 76 couples to an output of a voltage boost circuit 81.

Transistor 77 and capacitor 78 combine to store green video information. Transistor 77 includes a drain coupled to a green input, a gate coupled to the row enable input, and a source coupled to a first terminal of capacitor 78. A second terminal of capacitor 76 couples to the output of voltage boost circuit 81. Similarly, transistor 79 and capacitor 80 combine to store blue video information. Transistor 79 includes a drain coupled to a blue input, a gate coupled to the row enable input, and a source coupled to a first terminal of capacitor 80. A second terminal of capacitor 76 couples to the output of voltage boost circuit 81.

Storage stage 72 comprises transistors 83, 84, 86, 87, 89, and 90 and capacitors 85, 88, and 91. As mentioned previously, storage stage 72 outputs video information to LCD pixel 74 while new RGB video information for the next frame is stored in storage stage 71. Transistors 83 and 84, and capacitor 85 store red video information received from storage stage 71. Transistor 83 is in a voltage follower configuration and includes a drain coupled to supply voltage Vcc, a gate coupled to the first terminal of capacitor 76, and a source. Transistor 84 is in a pass transistor configuration and includes a drain coupled to the source of transistor 84, a gate coupled to a read1 input, and a source. Capacitor 85 includes a first terminal coupled to the source of transistor 84 and a second terminal coupled to an output of a voltage boost circuit 92.

Transistors 86 and 87, and capacitor 88 store green video information received from storage stage 71. Transistor 86 is in a voltage follower configuration and includes a drain coupled to supply voltage Vcc, a gate coupled to the first terminal of capacitor 78, and a source. Transistor 87 is in a pass transistor configuration and includes a drain coupled to the source of transistor 86, a gate coupled to Read1 input, and a source. Capacitor 88 includes a first terminal coupled to the source of transistor 87 and a second terminal coupled to the output of voltage boost circuit 92.

Transistors 89 and 90, and capacitor 91 store blue video information received from storage stage 71. Transistor 89 is in a voltage follower configuration and includes a drain coupled to supply voltage Vcc, a gate coupled to the first terminal of capacitor 80, and a source. Transistor 90 is in a pass transistor configuration and includes a drain coupled to the source of transistor 89, a gate coupled to the Read1 input, and a source. Capacitor 91 includes a first terminal coupled to the source of transistor 90 and a second terminal coupled to the output of voltage boost circuit 92.

Output stage 73 provides the red, green, and blue video information stored in storage stage 72 sequentially to the mirror of LCD pixel 74. Output stage 73 comprises transistors 94, 95, 96, 97, 98, and 99, and parasitic capacitor 100. Transistor 94 is in a pass transistor configuration and includes a drain coupled to the first terminal of capacitor 85, a gate coupled to a red enable input, and a source coupled to a gate of transistor 97. Transistor 95 is in a pass transistor configuration and includes a drain coupled to the first terminal of capacitor 88, a gate coupled to a green enable input, and a source coupled to the gate of transistor 97. Transistor 96 is in a pass transistor configuration and includes a drain coupled to the first terminal of capacitor 91, a gate coupled to a blue enable input, and a source coupled to the gate of transistor 97. Transistor 97 is in a voltage follower configuration and includes a drain coupled to supply voltage Vcc and a source coupled to the mirror of LCD pixel 74. Transistor 98 includes a drain coupled to the source of transistor 97, a gate coupled to a Reset1 input, and a source coupled to ground. Transistor 99 includes a drain coupled to the gate of transistor 97, a gate coupled to a Reset2 input, and source coupled to ground.

Operation of frame buffer 70 is described hereinafter. A row enable signal applied to the row enable input transitions from a low state to a high state turning on transistors 75, 77, and 79 to couple analog video information on the red, green, and blue inputs respectively to capacitors 76, 78, and 80. The output of voltage boost circuit 81 is at a ground potential. A Read1 signal applied to Read1 input is in a low state decoupling storage stage 72 from receiving video information from storage stage 71. After the video information is stored, the row enable signal transitions from the high state to a low state disabling storage stage 71 from receiving video information. The red, green, and blue video information is stored on capacitors 76, 78, and 80. This sequence is repeated row by row until an entire frame of the RGB video information is stored in the pixel array.

Next, capacitors 85, 88, and 91 are discharged to ground after storage stage 71 has stored the video information and prior to transferring the video information to storage stage 72. The output of voltage boost circuit 92 is at ground potential. Transistor 99 is enabled when a Reset2 signal applied to the Reset2 input transitions to a high state. A red enable signal, green enable signal, and blue enable signal are respectively applied to the red enable input, the green enable input, and the blue enable input. Transistors 94, 95, and 96 are enabled respectively discharging capacitors 85, 88, and 91 to a ground potential through transistor 99. Transistor 99 is enabled for a time period needed to discharge capacitors 85, 88, and 91 and then is disabled as the Reset2 signal transitions to a low state. Similarly, transistor 94, 95, and 96 are respectively disabled by the red, green, and blue enable signals when Reset2 transitions to the low state.

The Read1 signal then transitions from the low state to a high state enabling storage stage 72 to receive video information from storage stage 71. Voltage boost circuit 81 provides a voltage pulse of a predetermined magnitude to the second terminals of capacitors 85, 88, and 91 while the Read1 signal is in the high state. Storage stage 71 outputs voltages to storage stage 72 that are greater in magnitude than the red, green, and blue video information previously stored. The voltage at the first terminals of capacitors 85, 88, and 91 are increased by the magnitude of the voltage pulse from voltage boost circuit 81. The predetermined magnitude is chosen to compensate for the threshold voltage of transistors 83, 86, and 89 thereby charging capacitors 85, 88, and 91 respectively to a voltage equal to the voltage across capacitors 76, 78, and 80. Error correction circuit 82 is further voltage compensation that changes the magnitude of the voltage pulse from voltage boost circuit 81 to account for process variations and backbias effects on transistors 83, 86, and 89 that modify the threshold voltage. The Read1 signal transitions from the high state to a low state decoupling storage stage 72 from receiving video information for the next frame from storage stage 71. Storage stage 71 can now store new video information while storage stage 72 outputs its stored video information to LCD pixel 74.

Output stage 73 then sequentially outputs the red, green, and blue video information respectively stored on capacitors 85, 88, and 91. Voltage boost circuit 92 and error correction circuit 93 operates similarly to voltage boost circuit 81 and error correction circuit 82. Voltage boost circuit 92 compensates for the threshold voltage of transistor 97 (in a voltage follower configuration) by outputting a voltage pulse that increases the voltage at the first terminals of capacitors 85, 88, and 91 as they sequentially are coupled to the mirror of LCD pixel 74. It should be noted that it may be practical for voltage boost 81 to couple to the second terminals of capacitors 76, 78, and 80 and the second terminals of capacitors 85, 88, and 91 thereby eliminating voltage boost circuit 92 and error correction 93.

Capacitor 100 comprises parasitic capacitances that exist from the mirror of LCD pixel 74 to ground. A voltage pulse is applied to Reset1 to enable transistor 98 for a period of time needed discharge parasitic capacitor 100. Capacitor 100 is discharged prior to providing red, green, or blue video information to LCD pixel 74.

An example of a sequence for providing red, green, and blue video information to LCD pixel 74 is described hereinafter. The Read1 signal transitions from the high state to a low state decoupling storage stage 72 from receiving video information from storage stage 71. Red, green, and blue video information is respectively stored on capacitor 85, 88, and 91. Initially, capacitor 100 is discharged to ground potential and the red enable, green enable, and blue enable signals are in a low state. The output of voltage boost circuit 92 transitions to a predetermined voltage magnitude thereby increasing the voltage at the first terminals of capacitors 85, 88, and 91 to compensate for the threshold voltage of transistor 97. The red enable signal transitions from the low state to a high state enabling transistor 94. The red video information corresponding to the voltage across capacitor 85 is applied to the mirror of LCD pixel 74. The red video information biases LCD pixel 74 for approximately one third of the frame time and then the red enable signal transitions from the high state to a low state disabling transistor 94.

Capacitor 100 is then discharged by enabling transistor 98 briefly. The green enable signal transitions from the low state to a high state enabling transistor 95. The green video information corresponding to the voltage across capacitor 88 is applied to the mirror of LCD pixel 74. The green video information biases LCD pixel 74 for approximately the next third of a frame time and then the green enable signal transitions from the high state to a low state disabling transistor 95.

Once again, capacitor 100 is discharged by enabling transistor 98 briefly. The blue enable signal transitions from the low state to a high state enabling transistor 96. The blue video information corresponding to the voltage across capacitor 91 is applied to the mirror of LCD pixel 74. The blue video information biases LCD pixel 74 for the remaining frame time and then the blue enable signal transitions from the high state to a low state disabling transistor 96. Voltage boost circuit 92 transitions from the predetermined voltage magnitude to ground. Capacitors 85, 88, and 91 are then discharged to ground preparing storage stage 72 to transfer the next frame of RGB video information that was just stored in storage stage 71.

From the foregoing description, it should be appreciated that a frame buffer circuit has been designed for providing high contrast and linearity while operating at low supply voltages. Utilizing small channel length transistors allows a small frame buffer cell size that is suitable for LCD displays having millions of pixels which is required for high quality applications. The frame buffer has a first storage stage and a second storage stage that allows video information to be output by the second storage stage to a LCD pixel while the first storage stage is storing new video information. The video information stored in the first storage stage is output at a greater voltage magnitude than the originally stored value. The second storage stage receives the output of greater voltage magnitude and stores a voltage approximately equal to the originally stored voltage. This process increases the voltage range and linearity of the frame buffer.

While preferred exemplary embodiments have been presented in the foregoing detailed description, it should be appreciated that a vast number of variations in the embodiments exist. It should also be appreciated that these preferred embodiments are only an example and are not intended to limit the scope, applicability of configuration in any way. Rather, the foregoing detailed description provides those skilled in the art with a convenient roadmap for implementing the preferred exemplary embodiments of the invention. Various changes may be made in the function and arrangement described above without departing from the spirit and scope of the invention as set forth in the appended claims.

What is claimed is:

1. A circuit for providing video information to a liquid crystal display pixel comprising:
a first transistor having a first electrode coupled to a column input for receiving video information, a control electrode coupled to an enable input, and a second electrode;
a capacitor for storing video information having a first terminal coupled to said second electrode of said first transistor and a second terminal;
a storage stage for storing video information received from said capacitor, said storage stage having an input coupled to said first terminal of said capacitor, a read input, and an output coupled to a mirror of the liquid crystal display pixel; and
a voltage boost circuit having an output coupled to said second terminal of said capacitor.

2. The circuit as recited in claim 1 wherein said storage stage is disabled from storing video information when said first transistor is enabled for coupling video information applied to said column input to said capacitor.

3. The circuit as recited in claim 2 wherein said voltage boost circuit outputs a first voltage magnitude when video information is being stored on said capacitor.

4. The circuit as recited in claim 3 wherein said first transistor is disabled and said voltage boost circuit outputs a second voltage magnitude when said storage stage is enabled for storing video information such that a voltage provided to said input of said storage stage is different than a voltage stored on said capacitor.

5. The circuit as recited in claim 1 wherein said storage stage comprises:
a first transistor having a first electrode coupled for receiving a first supply voltage, a control electrode coupled to said input of said of said storage stage, and a second electrode;
a second transistor having a first electrode coupled to said second electrode of said first transistor, a control electrode coupled to said read input of said storage stage, and a second electrode coupled to said output of said storage stage; and
a capacitor having a first terminal coupled to said output of said storage stage and a second terminal coupled for receiving a second supply voltage; and
a third transistor having a first electrode coupled to said output of said storage stage, a control electrode coupled to a reset input, and a second electrode coupled for receiving said second supply voltage.

6. The circuit as recited in claim 5 wherein said second voltage magnitude of said voltage boost circuit is approximately a threshold voltage of said first transistor of said storage stage.

7. The circuit as recited in claim 1 wherein said storage stage comprises:
a first transistor having a first electrode coupled for receiving a first supply voltage, a control electrode coupled to said read input of said storage stage, and a second electrode;
a second transistor having a first electrode coupled to said second electrode of said first transistor, a control electrode coupled to said input of said storage stage, and a second electrode to said output of said storage stage;
a capacitor having a first terminal coupled to said output of said storage stage and a second terminal coupled for receiving a second supply voltage; and
a third transistor having a first electrode coupled to said output of said storage stage, a control electrode coupled to a reset input, and a second electrode coupled for receiving said second supply voltage.

8. A method for storing and providing video information to a liquid crystal display (LCD) pixel of a display comprising the steps of:
storing video information of a first voltage magnitude in a first storage stage;
coupling a second storage stage for receiving video information from said first storage stage;
outputting video information of a second voltage magnitude from said first storage stage to said second storage stage; and
storing video information of said first voltage magnitude in said second storage stage.

9. The method as recited in claim 8 wherein the step of coupling a second storage stage further includes a step of
decoupling said first storage stage from receiving video information.

10. The method as recited in claim 8 wherein said step of outputting video information of a second voltage magnitude further includes a step of adding voltage to said video information of said first voltage magnitude to generate said video information of said second voltage magnitude.

11. The method as recited in claim 8 further including the steps of:
decoupling said second storage stage from receiving video information from said first storage stage; and
coupling said first storage stage for receiving video information for a next frame.

12. The method as recited in claim 8 further including a step of providing video information stored in said second stage to the LCD pixel.

13. A frame buffer circuit for providing color sequential video information to a liquid crystal display pixel comprising:
a first storage stage having a first input, a second input, a third input, an enable input, a first output, a second output, and a third output;
a second storage stage having a first input, a second input, and a third input respectively coupled to said first, second, and third outputs of said first storage stage, an enable input, and a first output, a second output, and a third output;
a first transistor having a first electrode coupled to said first output of said second storage stage, a control electrode coupled to a first color enable input, and a second electrode;
a second transistor having a first electrode coupled to said second output of said second storage stage, a control electrode coupled to a second color enable input, and second electrode;
a third transistor having a first electrode coupled to said third output of said second storage stage, a control electrode coupled to a third color enable input, and a second electrode;
a fourth transistor having a first electrode coupled for receiving a first supply voltage, a control electrode coupled to said second electrodes of said first, second, and third transistors, and a second electrode coupled to the liquid crystal display pixel; and
a fifth transistor having a first electrode coupled to said second electrode of said fourth transistor, a control electrode coupled to a first reset input, and a second electrode coupled for receiving a second supply voltage.

14. The frame buffer as recited in claim 13 further including a sixth transistor having a first electrode coupled to said control electrode of said fourth transistor, a control electrode coupled to a second reset input, and a second electrode coupled for receiving said second supply voltage.

15. The frame buffer as recited in claim 14 wherein said first storage stage comprises:
a first transistor having a first electrode coupled to said first input of said first storage stage, a control electrode coupled to said enable input of said first storage stage, and a second electrode coupled to said first output of said first storage stage;
a first capacitor having a first terminal coupled to said first output of said first storage stage and a second terminal coupled to a fourth input of said first storage stage;
a second transistor having a first electrode coupled to said second input of said first storage stage, a control electrode coupled to said enable input of said first storage stage, and a second electrode coupled to said second output of said first storage stage;
a second capacitor having a first terminal coupled to said second output of said first storage stage and a second terminal coupled to said fourth input of said first storage stage;
a third transistor having a first electrode coupled to said third input of said first storage stage, a control electrode coupled to said enable input of said first storage stage, and a second electrode coupled to said third output of said first storage stage; and
a third capacitor having a first terminal coupled to said third output of said first storage stage and a second terminal coupled to said fourth input of said first storage stage.

16. The frame buffer as recited in claim 15 wherein an output of a voltage boost circuit couples to said fourth input of said first storage stage, wherein said voltage boost circuit provides a first voltage magnitude when storing video information in said first storage stage, and wherein said voltage boost circuit provides a second voltage magnitude when storing video information in said second storage stage.

17. The frame buffer as recited in claim 16 wherein said first, second, and third capacitors of said second storage stage are discharged prior to enabling said second storage stage for storing.

18. The frame buffer as recited in claim 14 wherein said second storage stage comprises:
a first transistor having a first electrode coupled for receiving said first supply voltage, a control electrode coupled to said first input of said second storage stage, and a second electrode;
a second transistor having a first electrode coupled to said second electrode of said first transistor of said second storage stage, a control electrode coupled to said enable input of said second storage stage, and a second electrode coupled to said first output of said second storage stage;
a first capacitor having a first terminal coupled to said first output of said second storage stage and a second terminal coupled to a fourth input of said second storage stage;
a third transistor having a first electrode coupled for receiving said first supply voltage, a control electrode coupled to said second input of said second storage stage, and a second electrode;
a fourth transistor having a first electrode coupled to said second electrode of said third transistor of said second storage stage, a control electrode coupled to said enable input of said second storage stage, and a second electrode coupled to said second output of said second storage stage;
a second capacitor having a first terminal coupled to said second output of said second storage stage and a second terminal coupled to said fourth input of said second storage stage;
a fifth transistor having a first electrode coupled for receiving said first supply voltage, a control electrode coupled to said third input of said second storage stage, and a second electrode;
a sixth transistor having a first electrode coupled to said second electrode of said fifth transistor of said second storage stage, a control electrode coupled to said enable input of said second storage stage, and a second electrode coupled to said third output of said second storage stage; and
a first capacitor having a first terminal coupled to said third output of said second storage stage and a second terminal coupled to a fourth input of said second storage stage.

19. The frame buffer as recited in claim 18 wherein an output of a voltage boost circuit couples to said fourth input of said second storage stage, wherein said voltage boost circuit provides a first voltage magnitude when storing video information in said second storage stage, and wherein said voltage boost circuit provides a second voltage magnitude when providing video information to the liquid crystal display pixel.

20. The frame buffer as recited in claim 19 wherein said second voltage magnitude output by said voltage boost circuit is approximately equal to a threshold voltage of said fourth transistor.
